(19) United States
(12) Patent Application Publication
(10) Pub. No.: US 2023/0149235 A1
(43) Pub. Date: May 18, 2023

(54) PORTABLE ISOLATION UNIT

(71) Applicants: The University of Melbourne, Melbourne, Victoria (AU); Western Health, Footscray, Victoria (AU)

(72) Inventors: Jason Patrick MONTY, Melbourne, Victoria (AU); Forbes MCGAIN, Victoria (AU)

(21) Appl. No.: 17/995,644

(22) PCT Filed: Apr. 6, 2021
(86) PCT No.: PCT/AU2021/050316

§ 371 Date: Oct. 6, 2022

(30) Foreign Application Priority Data
Apr. 8, 2020 (AU) 2020901125
Oct. 9, 2020 (AU) 2020903666

(51) Int. Cl. A61G 10/02; A61G 10/00

(52) U.S. Cl. CPC A61G 10/02; A61G 10/005

(57) ABSTRACT

A portable isolation unit for use with a bed or chair, including an enclosure portion configurable between a stowed state and a deployed state, in which the enclosure portion substantially shields over an end of the bed or chair; a ventilation unit configured for applying air pressure to an area beneath the enclosure portion when the enclosure portion is in the deployed state; and a portable frame to which the enclosure portion and ventilation unit are mounted.

### FIELD OF THE INVENTION

This invention relates to an isolation unit for patient care, and in particular a portable isolation unit for use in a hospital environment for isolating patients with infectious diseases.

### BACKGROUND

Frontline healthcare workers in the treatment and care of patients suffering from highly infectious airborne diseases, such as the COVID-19 global pandemic, are particularly at risk of becoming infected themselves. Problems are exacerbated when hospitals and healthcare facilities are stretched beyond their capacities, resulting in a shortage of specialist hospital rooms and equipment ordinarily prepared to accommodate patients with infectious diseases. Inadequate physical protection for healthcare workers against infectious diseases has dire consequences for a community's ability to treat the sick and stem the spread of the disease, and therefore there is a strong need for an adequate solution to protect healthcare workers when patients are treated outside specialist hospital containment rooms, such a negative pressure rooms, or in circumstances where such negative pressure rooms are not effective in preventing the spread of a disease.

For example, healthcare workers treating a patient infected with the SARS-CoV-2 virus could be highly exposed to the virus either directly by a patient coughing/sneezing or indirectly by touching contaminated instruments, bedding or equipment, as the virus appears to be transmitted through droplets originating from the respiratory tract expelled from a patient through coughing, sneezing or breathing. A challenge with containing viral droplets expelled by humans is that the many droplets are large (>10 micron), at least initially prior to evaporation, and cannot be effectively evacuated from the vicinity of a patient by mechanical means such as ventilation, and typical negative pressure rooms do not have the airflow speed to carry such large droplets. Furthermore, studies suggest that only a very small percentage of droplets expelled by a patient, which may potentially carry live virus, could be captured through a carefully designed ventilation system. Additionally, the common “whole of room” approach to negative pressure room ventilation carries significant risk of spreading a viral disease around the room in an unknown fashion, particularly in emergency situations where containment may be constantly disrupted by necessary adjustments in the number of hospital beds and equipment, or having many healthcare workers rushing around the room in an emergency.

Therefore, there exists a need for a solution that protects healthcare workers from viral droplets expelled by patients while minimising any interference or disruption to the workers' ability provide adequate treatment and care for the affected patients. The solution should also be able to meet strict hospital-grade hygiene and cleaning standards and, ideally, not be exorbitantly expensive to produce.

The applicant has determined that it would be advantageous to provide an isolation unit that is portable and which, in its preferred embodiments, seeks to at least in part alleviate the above-identified problems or to offer the public with a useful choice.

### SUMMARY OF THE INVENTION

According to an aspect of the present invention, there is provided a portable isolation unit for use with a bed or chair, comprising an enclosure portion configurable between a stowed state and a deployed state, in which the enclosure portion substantially shields over an end of the bed or chair; a ventilation unit configured for applying air pressure to an area beneath the enclosure portion when the enclosure portion is in the deployed state; and a portable frame to which the enclosure portion and ventilation unit are mounted.

Preferably, the enclosure portion substantially shields over an end of the bed or chair so as to be positioned over at least a head portion of a user during use.

Preferably, the enclosure portion comprises a sheet cover held in place by one or more support members.

Preferably, the sheet cover is made from a transparent plastic material.

Preferably, the or each support member is a resilient rod configured in the form of an arch for supporting the sheet cover, and the rod extends substantially across a width of the enclosure portion.

Preferably, the enclosure portion comprises a plurality of complementary arched resilient rods spaced along the sheet cover, and wherein respective ends of the arched rods are conjoined or located proximate each other so as to create a foldable hood.

Preferably, fastening means are provided along the or each support member for coupling with the sheet cover.

Alternatively, the or each support member directly engages with the sheet cover.

Preferably, the sheet cover comprises a skirt portion, which is dimensioned to extend below a support member towards a surface of the bed or chair during use. Preferably, the skirt portion does not form an air-tight seal between the enclosure portion and the bed during use so that the air within the enclosure portion is breathable without activation of the ventilator unit.

Preferably, the portable frame is an upright frame having a portable base.

Preferably, the portable base comprises a set of caster wheels.

Alternatively, the portable frame is configured to be attachable to the bed or chair.

Preferably, the portable frame comprises an upright mounting frame for coupling with the enclosure portion.

Preferably, the mounting frame is configured so that its height is adjustable.

Preferably, a wall member is sealably coupled to the mounting frame so as to create a substantially sealed backing member for mounting the enclosure portion.

Preferably, the mounting frame and/or the wall member is provided with an opening for sealably receiving a conduit portion which is coupled to the ventilation unit during use.

Preferably, the opening is located at or proximate a part of the mounting frame and/or the wall member that is furthest from a head portion of a user during use.

Alternatively, the portable frame comprises a backing member for supporting the enclosure portion in the deployed state.

Preferably, the isolation unit further comprises clamping means mountable to the backing member for coupling the portable frame to the bed or chair.

Preferably, the clamping means comprises a bracket having one or more hooks configured to be slideably receivable by a frame of the bed or chair so as to secure the clamping means in position by friction fit.

Preferably, the bracket is configured to accommodate the width and thickness of a support mattress or cushion of the bed or chair when the mattress or cushion is inserted therethrough.

Preferably, the backing member is provided with an opening to which the ventilation unit or a conduit portion of which is mounted thereto.

Preferably, the opening is located at or proximate a part of the backing member that is furthest from a head portion of a user during use

Preferably, the ventilator comprises a fan unit and a filter unit, wherein the filter unit is configured to filter airflow entering or exiting the fan unit.

Preferably, the filter unit is a HEPA filter.

Preferably, the ventilation unit is configured to provide negative air pressure to an area beneath the enclosure portion when the enclosure portion is in the deployed state.

Alternatively, the ventilation unit is configured to provide positive air pressure to an area beneath the enclosure portion when the enclosure portion is in the deployed state.

Preferably, the ventilation unit is provided with a portable power source, which is mountable to the portable frame.

According to another aspect of the present invention, there is provided a portable isolation unit kit comprising an enclosure portion, a ventilation unit and a portable frame as described previously.

According to a further aspect of the present invention, there is provided a method of deploying a portable pressurised chamber over a head portion of a user on a bed or chair, the method involves the steps of: providing a portable isolation unit according to any one of the preceding claims; locating the portable frame to or proximate a head end of the bed; adjusting the enclosure portion to the deployed state so that the enclosure portion substantially shields over the head portion of the user during use; and activating the ventilation unit to apply negative or positive air pressure to an area under the deployed enclosure portion.

Further aspects of the present invention and further embodiments of the aspects described in the preceding paragraphs will become apparent from the following description.

While components of the portable isolation unit will be described below for use in combination with each other in the preferred embodiments of the present invention, it is to be understood by a skilled person that some aspects of the present invention are equally suitable to be used interchangeably between one or more embodiments of the present invention and/or suitable for use as standalone inventions that can be individually incorporated into other isolation unit and systems not described herein.

### DESCRIPTION OF THE DRAWINGS

The invention will now be described, by way of non-limiting example only, with reference to the accompanying drawings, in which:

FIG. 1 is a perspective exploded view of a portable isolation unit according to an embodiment of the present invention;

FIG. 2 is a perspective view showing an assemble unit of FIG. 1 in a deployed state;

FIG. 3 is a perspective view showing an assembled unit of FIG. 1 in an open state;

FIG. 4 shows a perspective schematic view of the assembled unit of FIG. 1 in a deployed state located proximate an end of a bed;

FIG. 5 shows a front schematic view of the assembled unit and bed of FIG. 4;

FIG. 6 is a schematic view of a cover portion of the isolation unit showing computational fluid dynamics (CFD) simulation results;

FIG. 7 shows a set of CFD simulation results of the cover portion of FIG. 4 over time;

FIG. 8 shows a set of CFD simulated results of using the isolation unit in a negative pressure room;

FIG. 9 shows simulated trajectories of particle flowing inside the cover portion of the portable isolation unit;

FIG. 10 shows a set of smoke visualisation results for testing the ventilation effectiveness of an embodiment of the portable isolation unit over time;

FIG. 11 shows a perspective view from the side of a portable isolation unit according to another embodiment of the present invention mounted to a bed;

FIG. 12 shows a perspective view from the rear of the portable isolation unit of FIG. 11;

FIG. 13 shows a front view of the portable isolation unit of FIG. 11;

FIG. 14 shows a perspective view from the view of a portable isolation unit of FIG. 11 in another mounting configuration; and

FIG. 15 shows a perspective view from the front of a portable isolation unit according to a further embodiment of the present invention;

FIG. 16 shows a rear perspective view of the portable isolation unit of FIG. 15;

FIG. 17 is a side view of the portable isolation unit of FIG. 15;

FIG. 18 is a partial exploded view of the portable isolation unit of FIG. 15; and

FIG. 19 is an exploded view of the portable isolation unit of FIG. 15.

### DETAILED DESCRIPTION

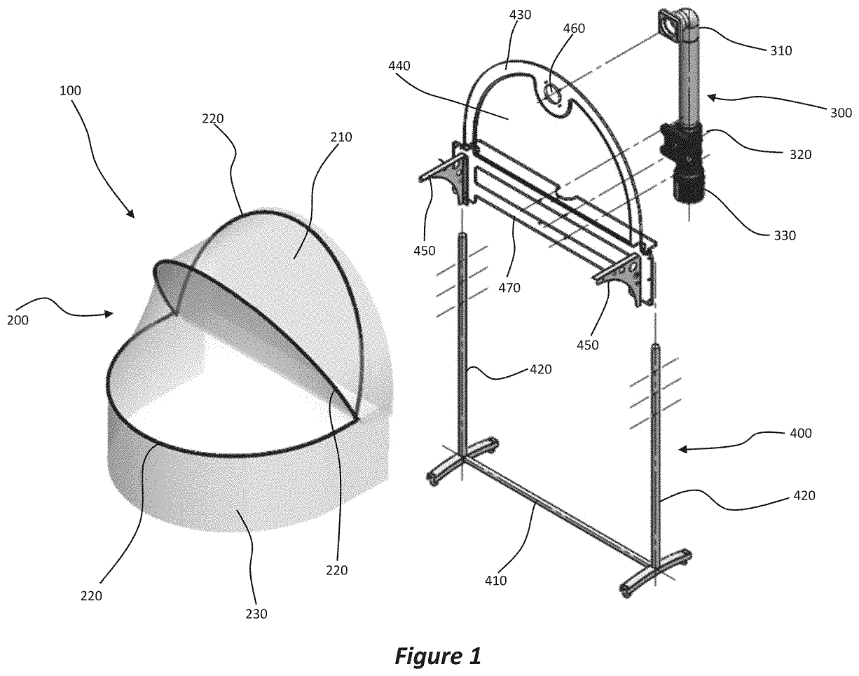

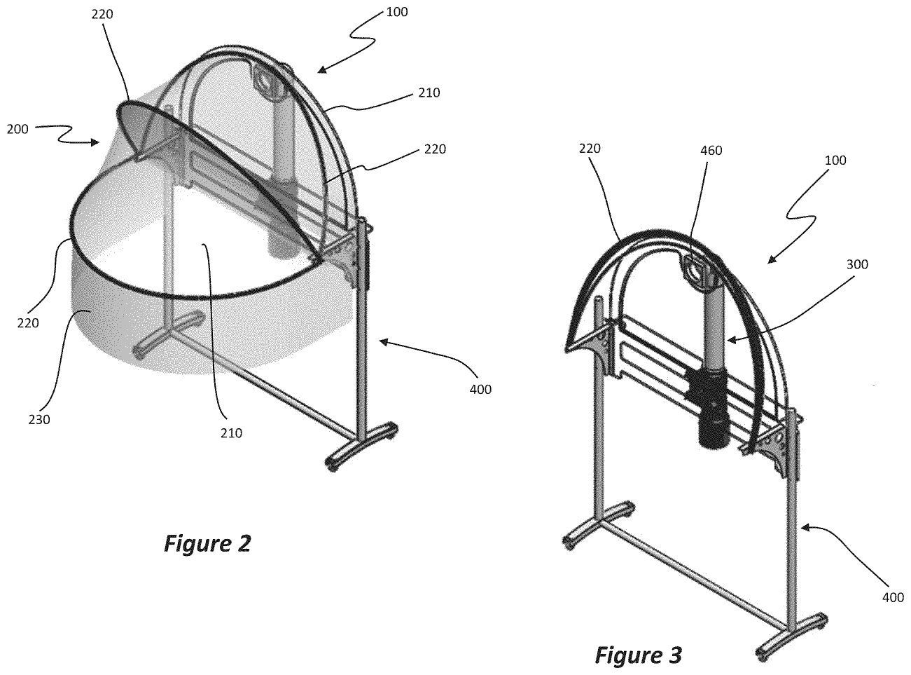

FIGS. 1 to 5 show a portable isolation unit 100 in accordance with a preferred embodiment of the present invention having an enclosure portion 200, a ventilation assembly 300 and a portable frame unit 400. The portable isolation unit 100 is designed to be easily transportable/portable and locatable proximate a head end of a bed 110 or chair for supporting/carrying patients (such as a hospital bed, ambulance stretcher paramedic stretcher or wheelchair) for providing a localised negative pressure environment over a head, and optionally torso, portions of a user during use. In other embodiments, the unit 100 may be configured to provide positive pressure to an area beneath the enclosure portion 200 during use. Preferred embodiments of the portable isolation unit 100 advantageously provide personalised shielding for patients with infectious diseases and allow healthcare workers to provide patients with ventilation treatments and on-going care with reduced risks of exposure to viral particles expelled by such patients. While the portable isolation unit 100 will be shown to be applicable for use with conventional hospital beds in the Figures, it is to be understood that it will be equally suitable for use with various other chairs or bedding platforms that are not described herein.

In the preferred embodiment, the enclosure portion 200 is in the form of a foldable hood that can be folded between a stowed position to minimise storage area and a deployed position, in which the hood can be fully or partially opened into a shell or pod shape to create a semi-enclosed area under the hood. In use, the enclosure portion 200 is deployed over an end of a bed or chair to substantially create a shield above and/or adjacent a user's head. The enclosure portion 200 comprises a sheet cover 210 and one or more support members 220 for holding the sheet cover 210 in place in the deployed state. In one embodiment, fastening means 225, such as clips or hook and loop strips, are provided along the one or more support members 220 for coupling with the sheet cover 210, while in other configurations, the one or more support members 220 directly engage with the sheet cover 210 to secure the cover 210 in place by, for example, stretching the cover 210 across the support member 220. The sheet cover 210 is preferably of a clear, transparent material so as to allow full visibility between the user and healthcare workers in use which reduces any communication impediments created by the isolation unit 100. The sheet cover 210 can be manufactured from any suitable material such as plastic, but glass may be used in other configurations.

In the foldable hood embodiment, the sheet cover 210 is supported by the support members 220 in the form of resilient rods 220 configured as support arches that stretch outwardly across a width of the sheet cover 210 so as to hold the cover 210 and the resilient rods 220 in place. The support arches are spaced relative to each other along the folding direction of sheet cover 210 to create a cascading or concertinaed hood. In the preferred embodiment, the respective ends of the resilient rods, which create the support arches, are conjoined or located proximate each other. It is to be understood that while the enclosure portion 200 has been described as a foldable hood in the preferred embodiment, other configurations are possible without departing from the spirit of the invention. For example, in some configurations, the foldable hood may be provided with only a single resilient rod member 220 to support the sheet cover 210 and the respective ends of the resilient rod 220 could be secured instead in a staggered fashion. Additionally, in one example, the enclosure portion 200 could comprise a preformed sheet cover 210 supported by elongate struts positioned at both sides of the cover 210.

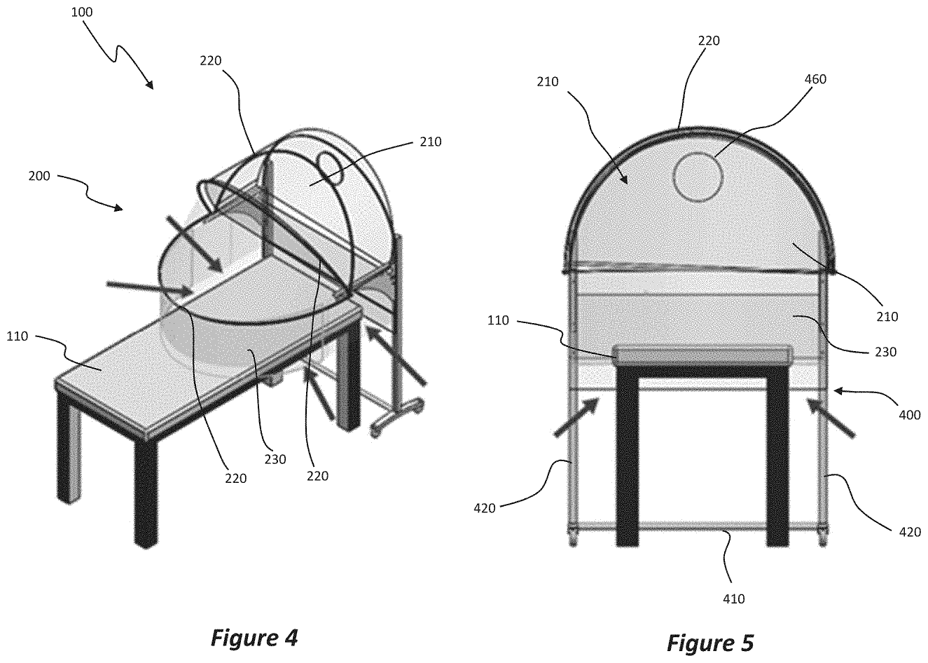

In the preferred embodiment, with reference to FIGS. 4 and 5, the sheet cover 210 further comprises a skirt portion 230 which is dimensioned to drape or overhang below a support member 220, when the enclosure portion is in the deployed state, towards a surface of, and beside, the bed 110 during use. This skirt portion 230 helps substantially shield a head and torso portion of the user from the external environment and advantageously allows the enclosure portion 200 to be versatile in accommodating a wide range of users with different physical body dimensions in use. Importantly, while the skirt portion 230 substantially shields the user from the external environment, it does not form an air-tight seal with the bed 110 or chair during use so that the user who is enclosed beneath the enclosure portion 200 on the bed or chair could still breathe normally from surrounding ambient air (shown as arrows) passing through gaps formed between the skirt 230 and edge of the bed 110 or chair so that the user does not asphyxiate, even without activation of the ventilation system 300.

Turning now to the portable frame 400, which provides means for accommodating the enclosure portion 200 and the ventilator system 300. In the preferred embodiment, the portable frame 400 is in the form of an upright frame having a portable base 410, a height adjustable upright frame members 420, a mounting frame 430 and backing wall 440 for mounting the enclosure portion 200 and brackets 450 for supporting the resilient rods 220 when the sheet cover 210 is in the deployed state. The portable base 410 is configured with a set of caster wheels; however, other suitable transportations means may also be used. The height adjustable upright frame members 420 are configured with mounting holes for easy adjustment of the height of the isolation unit 100 relative to a bed, though other adjustability means such as nested telescopic members, whether powered or manually adjusted, could also be used. The mounting frame 430 could be configured with a shape that is complementary to that of the sheet cover 210, such as a semi-circular arched shape, for mounting the sheet cover 210; however, any other suitable shapes can also be used. The backing wall 440 is sealingly installed to the mounting frame 430 to provide a substantially sealed backing area to encase a back side of the enclosure portion 200 in the deployed state. In the preferred embodiment, the support brackets 450 are configured for coupling with respective ends of the resilient rods 220 and to retain the foldable hood in an open position in the deployed state. In one embodiment, the portable frame 400 is configured to be mountable attachable directly to the bed or chair with or without the use of the frame members 420.

The portable frame is also provided with an opening or port 460 for sealably interfacing with a conduit portion 310 of the ventilator system 300. In the preferred embodiment, the port 460 is defined by the mounting frame 430, though in other configurations, the port 460 could also be defined by the backing wall 440. In one configuration, the port 460 is located at an upper part of the portable frame so that, when in use, the port 460 is located furthest from a head portion of user to minimise interference of airflow and to improve the ability of the ventilation system 300 to draw air from the enclosed area.

The ventilation system 300 comprises a fan unit 320, a filter unit 330, which is configured to filter airflow entering or exiting the fan unit 320, with the conduit portion 310 sealingly connecting the fan unit 320 and the port 460. In one configuration, the fan unit 320 is an exhaust fan configured to extract air from the area under the enclosure portion 200 via the port 460; effectively creating a negative airflow pressure in the area to reduce any outward spread of particles containing viral droplets expelled by the user. The fan unit 320 and the filter unit 330 are preferably mounted to the portable frame 400 by coupling to a backing board 470. In one configuration, the filter unit 330 associated with the fan unit 320 is a high-efficiency particulate air (HEPA) filter unit. In other configurations, airflow of the fan unit 320 is either reversible or configured so that the fan unit 320 generates airflow into the enclosure portion 200 from external surroundings, thereby providing a positive filtered air pressure environment beneath the enclosure portion 200. In one embodiment, the ventilation system 300 is provided with a portable power source 560 in the form of a battery unit for powering the ventilation system 300 when the isolation unit 100 is moved away from mains power.

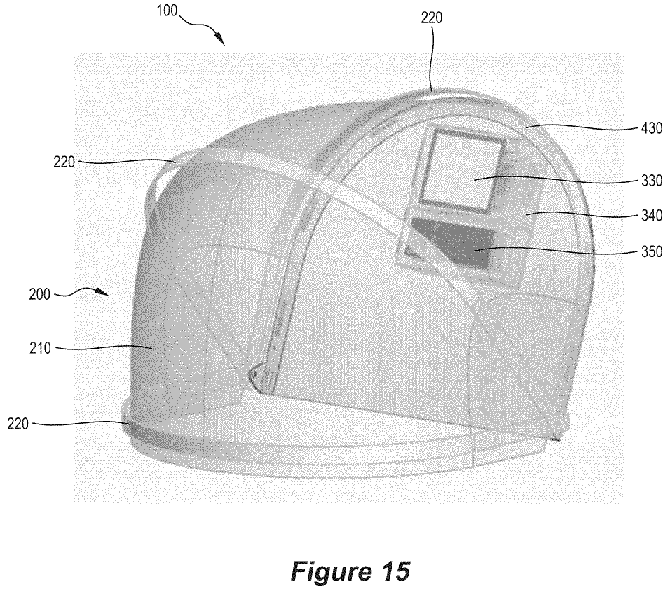

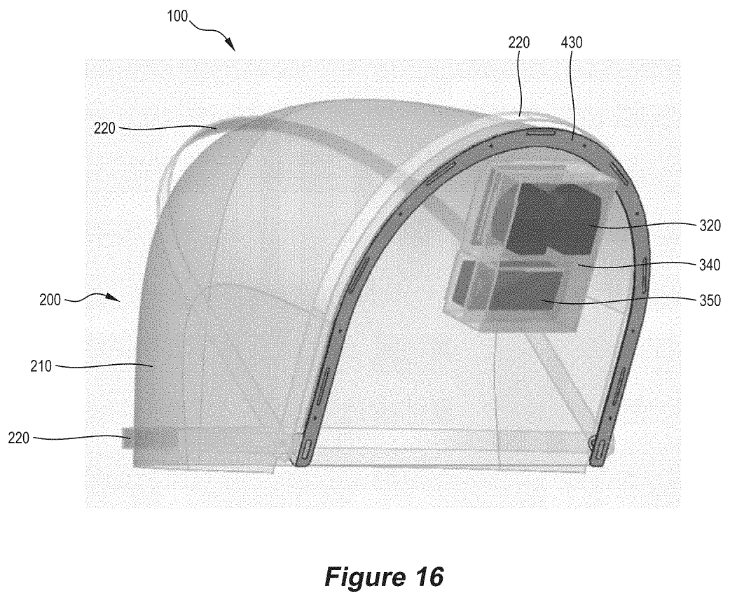

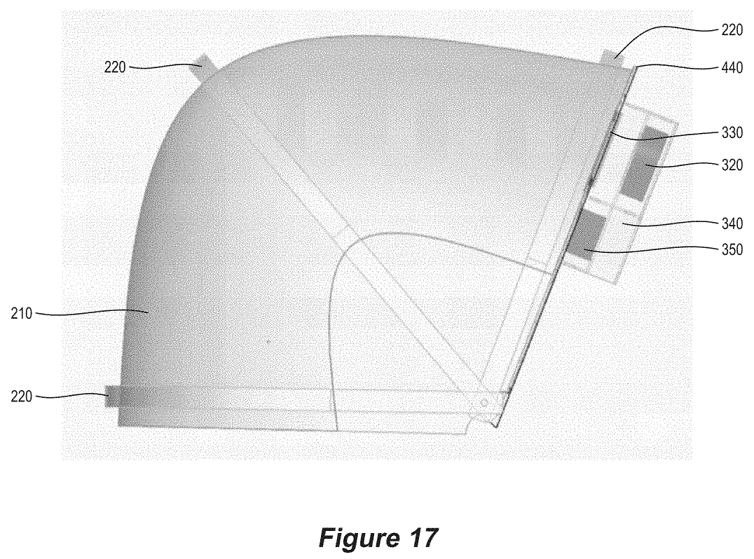

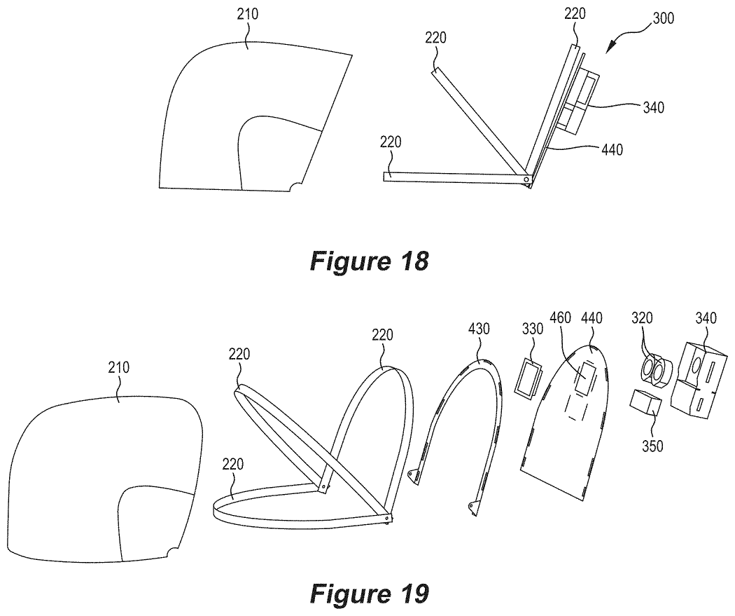

Another embodiment of the invention is illustrated in FIGS. 15 to 19, in which there is provided an isolation unit 100 with a ventilation system 300 that is more portable. In this embodiment, the enclosure 200 is configured substantially as described above, but the ventilation system 300 comprises a compact ventilation housing 340 mounted proximate the port 460 and the system housing 340 accommodates one or more fan units 320 mounted adjacent the filter unit 330, which is located over the port 460, and a portable power source 350 such as a battery for powering the filter unit 330.

The portable isolation unit 100 as described herein may also be provided as a kit of parts.

In use, a portable pressurised chamber can be deployed over a head portion of a user on, for example, a hospital bed or a wheelchair by using the following method steps: providing a portable isolation unit 100 as described above; locating the portable frame 400 to or proximate a head end of the bed or chair; opening the enclosure portion 200 to the deployed state so that the enclosure portion substantially shields over the head portion of the user during use; and activating the fan unit 320 of the ventilation system 300 to apply negative or positive air pressure to an area under the deployed enclosure portion.

Embodiments of the portable isolation unit 100 as described herein advantageous mitigate the risk of exposure by healthcare workers to contaminated particles expelled by an infected patient by providing the following benefits:
Providing a physical, transparent barrier around an infected patient;
Ensuring larger droplets from the nose and mouth of the patient are confined behind a protective barrier;
Capturing smaller droplets (aerosols) and expel through a filter system;
Not requiring to substantially alter the pressure, temperature or airflow of the treatment room, in the surrounding area external to the hood;
Allowing the patient to be provided with high-flow oxygen, CPAP or ventilator breathing support within the confines of the isolation environment;
Allowing continued interactions and interventions between healthcare workers and the patients with significantly reduced risk of infection for healthcare worker;
Being removable/movable in case of emergency procedures requiring uninhibited access to the patient;
Being easily and effectively cleaned; and
Using readily accessible components that are cost-effective to manufacture and to produce at scalable quantities.

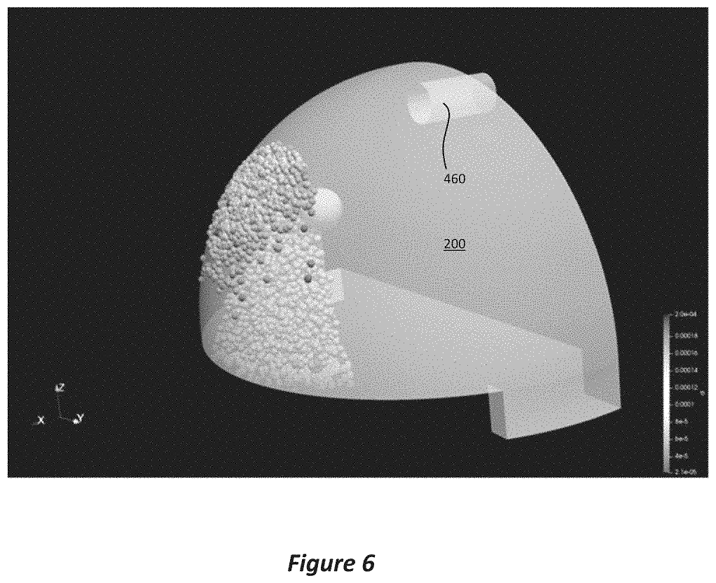

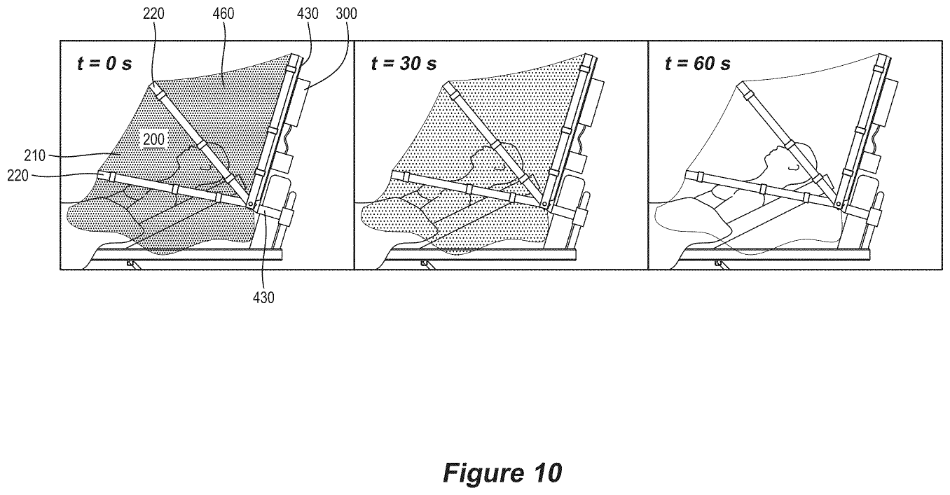

Returning now to the half-dome shape design of the enclosure portion 200 of the preferred embodiment with reference to FIG. 6, extensive computational fluid dynamics (CFD) simulation have been conducted to demonstrate the effective of the design. Simulations demonstrate that large droplets (indicated by orange coloured dots) are caught by the enclosure portion 200 in the deployed state, while smaller droplets are extracted through the ventilation system 300 by the exhaust fan unit 320 via a port 460 located at an upper portion of the enclosed area. FIG. 10 shows a complementary smoke visualisation test over time which demonstrates that smoke particles (analogous to smaller respiratory droplet particles) can be effectively cleared from the enclosed area by the ventilation system 300.

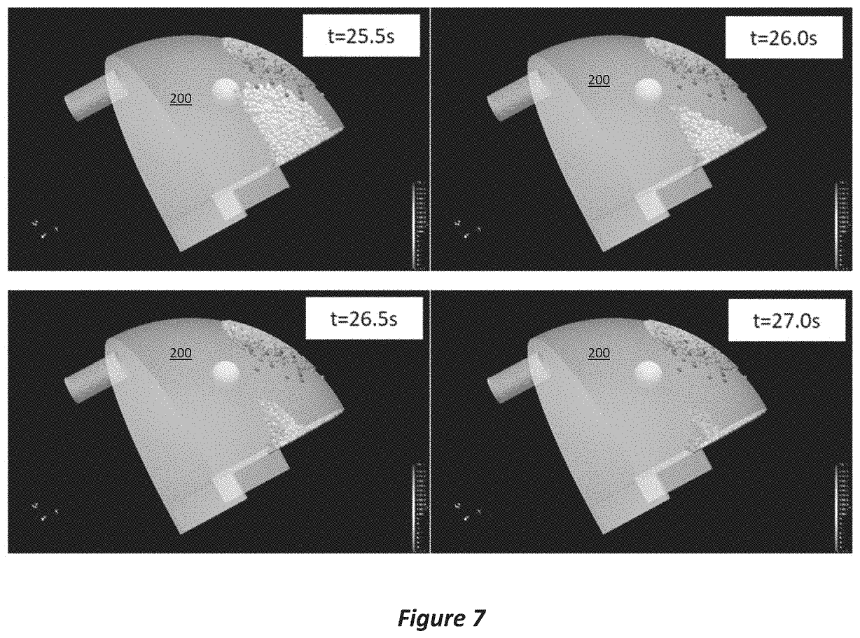

FIG. 7 shows a set of CFD simulation results of the cover portion of FIG. 4 over time. The simulation is conducted assuming the patient has been coughing for 5 seconds (from 20 s to 25 s). The patient's mouth is located at (x,y,z)=(0.3, 0, 0.3). This is indicated by the green sphere in the figure below. The diameter of the particles is assumed to have a mean of 100 micron and variance of 35 micron. The particles are assumed to have constant mean velocity of 11.2 m/s (typical velocity of someone coughing). Results at t=25.5 s, 26 s, 26.5 s and 27 s as shown. The droplets are coloured by their size. Red indicate larger particles and the smaller particles are coloured blue. This Figure shows that the larger particles have hit the walls of the pod after 0.5 s. The smaller particles (indicated by blue colour) takes longer to drop to the lower walls of the pod.

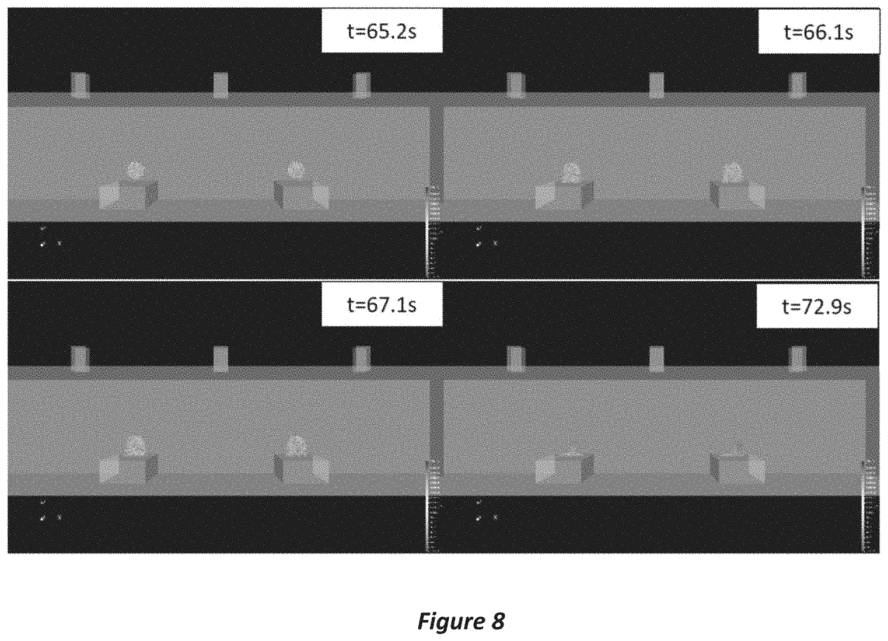

FIG. 8 shows a set of CFD simulated results of using the isolation unit in a negative pressure room. The simulations are conducted with two patients in two beds coughing. The diameter of the droplets is assumed to have a mean of 100 micron and variance of 35 micron. The particles are assumed to have constant mean velocity of 11.2 m/s (typical velocity of someone coughing). Results at t=65.2 s, 66.1 s, 67.1 s and 72.9 s are shown in the Figure. It can be seen that the droplets do not fall too far away from the patients. The width of the bed is 1 m so most of the droplets do not travel more than 0.3-0.4 m away from the patient's mouth.

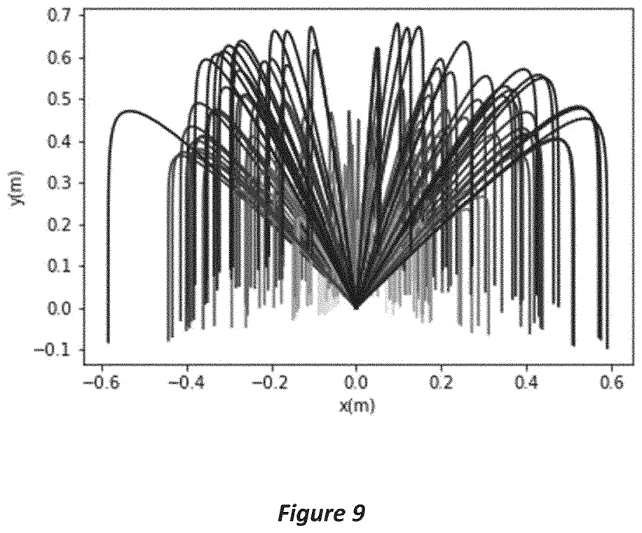

FIG. 9 shows simulated trajectories of particle flowing inside the cover portion of the portable isolation unit by conducting simulations of the trajectory of the particles without any flow (ie. U=V=0). The following parameters were used. Density of air=1.225 kg/m\hat{ }3, density of droplet=997 kg/m\hat{ }3, droplet diameter has a mean 100 micron and standard deviation of 35 micron, kinematic viscosity or air=1.470e-5 m\hat{ }2/s. In FIG. 7, the simulated patient's mouth is located at x=y=0. The darker lines are trajectory of larger particles and the lighter lines are trajectory of the lighter particles. The simulations are conducted in is (physical time). It is clear that the lighter droplets fall closer to the patient and the larger particles fall further away. This simulation also shows that all droplets land within 0.6 metres of the patient's mouth.

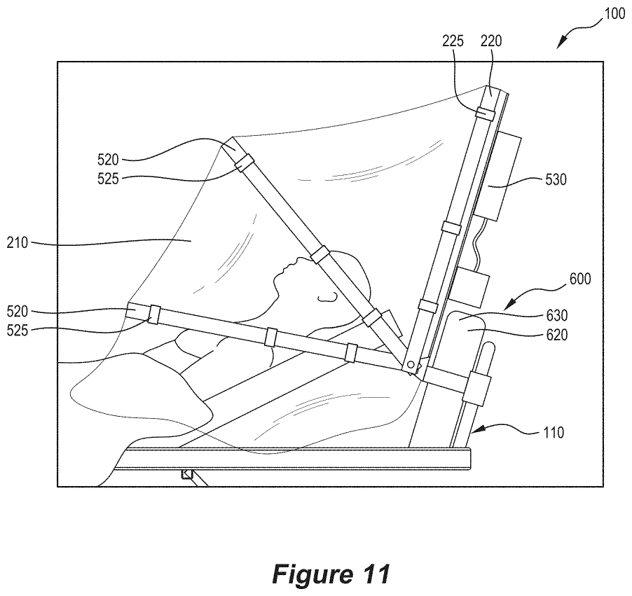

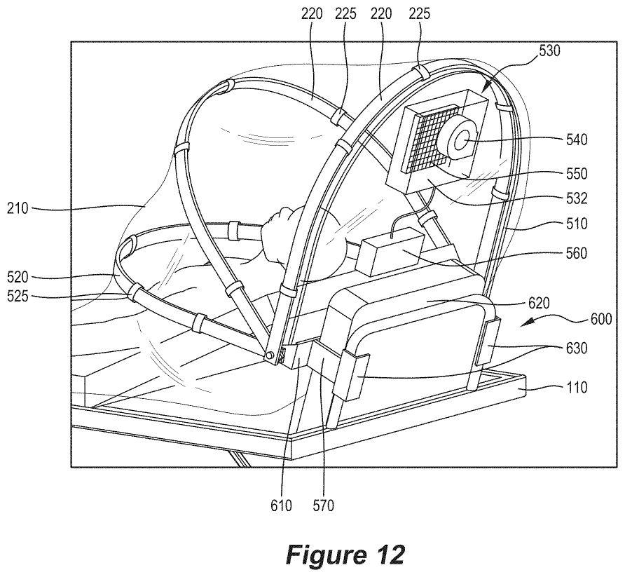

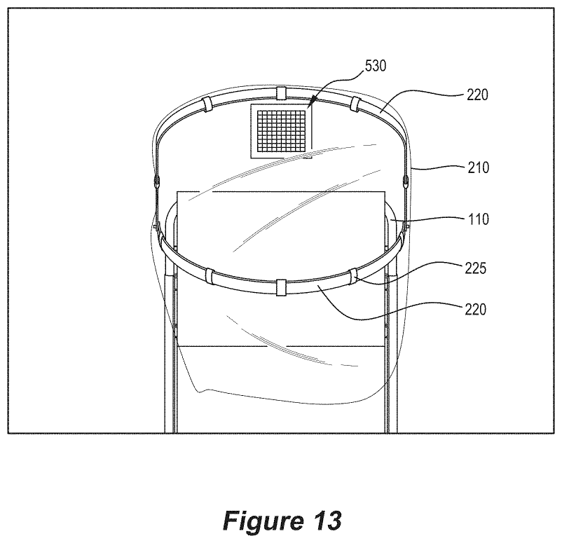

FIGS. 11 to 14 show another preferred embodiment of the present invention in which the portable frame 500 is designed to be secured to a patient-carrying or -transferring apparatus, such as a hospital bed, an ambulance bed or a wheelchair, without requiring the isolation unit 100 to have separate wheeled frames. In this embodiment, the portable frame 500 comprises a complementarily shaped backing member 510 for coupling with the mounting frame or the support member 210 that is closest to the ventilation unit 300, so as to provide structural support to the enclosure portion 200 in its deployed state and for mounting the isolation unit 100 to a frame portion of the bed or chair. In the preferred embodiment, the backing member 510, has at one end, an arcuate portion that is shaped to match the arch of the mounting frame or the support member 210, and, at an opposing end, clamping mounts 570 located proximate left and right side edges of the backing member 510 for receiving suitable clamping means 600 for coupling the support members 210 and for securing the portable frame 500 of the isolation unit 100 to the bed or chair.

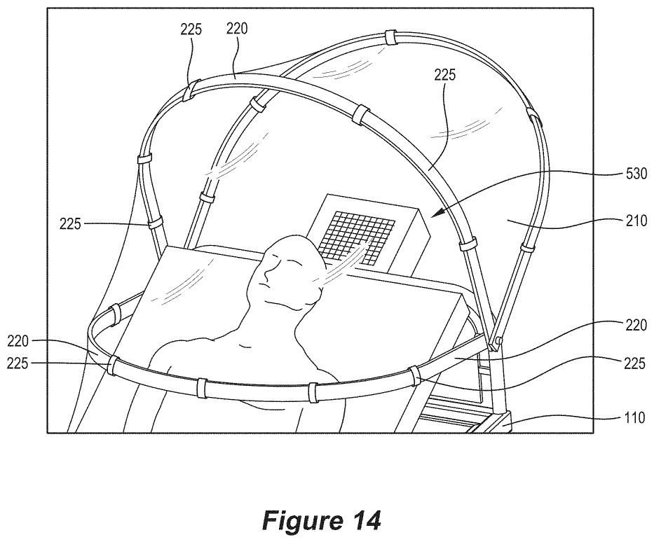

In one embodiment, the clamping means 600 comprises an angle bracket 610, to which one end of the one or more support members 210 of the enclosure portion 200 is secured, a frame bracket 620 dimensioned for receiving a support mattress or cushion of the bed or chair therethrough, and one or more hooks 630 configured to be slideably received by a frame portion 640 of the bed or chair so as to secure the clamping means 600 in position by friction fit. Using the clamping means 600 as described, the portable frame 500 may be mounted to the bed or chair in a number of configurations, depending on the orientation of a head frame portion of the bed or chair. The head frame portion 640 being the frame portion suitable for mounting that is located closest to a user's head. For example, the portable frame 500 may be mounted to a bed or chair with its head frame portion 640 orientated in a substantially upright position by inserting the frame bracket 620 over any mattress or cushion and sliding the hooks 630 over a frame portion 640 of the bed or chair until clamping means 600 is secured to the frame portion 640 by friction fit. The frame portion 640 of the bed or chair may be subsequently adjusted to alter an angle of the bed or chair to cater for user comfort. In such cases, orientation of the enclosure portion 200 of the isolation unit 100 mounted to the bed or chair would also move to accommodate the new position. Referring to FIG. 14, the portable frame 500 is oriented in a substantially horizontal position after the frame portion 640 of the bed is adjusted to allow the user to lie at a lower angle with respect to a horizontal plane.

While a friction-fit example has been provided for mounting the portable frame 500 to a frame portion 640 of a bed or chair, other mounting mechanisms such as a jaw-type clamp may also be suitable without departing from the spirit of the invention.

In the preferred embodiment, the backing member 510 is a transparent plate made from a plastic material, though other materials may also be suitable. The backing member 510 is provided with a port 520 for mounting a ventilation unit 530. The ventilation unit 530 is substantially similar to the unit described earlier and capable of providing negative and/or positive air pressure to the area beneath the enclosed portion 200, though in one embodiment a fan unit 540 and a filter unit 550 are mounted directly to the port 520 without the use of a separate conduit or air duct. In other embodiments,

In the description and drawings of this embodiment, same reference numerals are used as have been used in respect of the first embodiment, to denote and refer to corresponding features.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### REFERENCE NUMERALS

100 portable isolation unit
110 bed unit
200 enclosure portion
210 sheet cover
220 support member
225 fastening means
230 sheet portion
300 ventilation system
310 conduit
320 fan unit
330 filter unit
340 ventilation housing
350 portable power source
400 portable frame
410 base
420 upright frames
430 mounting frame
440 backing wall
450 support brackets
460 port
470 ventilation mounting board
500 portable frame
510 backing member
520 port
530 ventilation unit
532 ventilation housing
540 fan unit
550 filter unit
560 portable power source
570 clamping mount
600 clamping means
610 angle bracket
620 frame bracket
630 hook
640 frame portion of bed or chair

1. A portable isolation unit for use with a bed or chair, comprising:
an enclosure portion configurable between a stowed state and a deployed state, in which the enclosure portion substantially shields over an end of the bed or chair;
a ventilation unit configured for applying air pressure to an area beneath the enclosure portion when the enclosure portion is in the deployed state; and
a portable frame to which the enclosure portion and ventilation unit are mounted.

2. A portable isolation unit according to claim 1, wherein the enclosure portion does not form an air-tight seal with the bed.

3. A portable isolation unit according to claim 1, wherein the enclosure portion is configured to substantially shield over an end of the bed or chair so as to be positioned over at least a head portion of a user during use; and wherein the enclosure portion comprises a sheet cover held in place by one or more support members.

4. (canceled)

5. (canceled)

6. A portable isolation unit according to claim 3, wherein each support member is a resilient rod configured in the form of an arch for supporting the sheet cover, and the rod extends substantially across a width of the enclosure portion.

7. A portable isolation unit according to claim 6, wherein the enclosure portion comprises a plurality of complementarily arched resilient rods spaced along the sheet cover, and wherein respective ends of the arched rods are conjoined or located proximate each other so as to create a foldable hood.

8. (canceled)

9. (canceled)

10. A portable isolation unit according to claim 3, wherein the sheet cover comprises a skirt portion, which is dimensioned to extend below a support member towards the bed or chair during use.

11. A portable isolation unit according to claim 1, wherein the portable frame is an upright frame having a portable base, and the upright frame is configured for coupling with the enclosure portion.

12.-15. (canceled)

16. A portable isolation unit according to claim 11, wherein a wall member is sealably coupled to the mounting frame so as to create a substantially sealed backing member for mounting the enclosure portion.

17. A portable isolation unit according to claim 16, wherein the mounting frame and/or the wall member is provided with an opening for sealably receiving a conduit portion which is coupled to the ventilation unit during use.

18. A portable isolation unit according to claim 17, wherein the opening is located at or proximate a part of the mounting frame and/or the wall member that is furthest from a head portion of a user during use.

19. A portable isolation unit according to claim 1, wherein the portable frame comprises:
a backing support member configured to support the enclosure portion in the deployed state; and
a clamp configured to be mounted to the backing support member and configured to couple the portable frame to the bed or chair.

20. (canceled)

21. A portable isolation unit according to claim 19, wherein the claim comprises a bracket having one or more hooks configured to be slideably receivable by a frame of the bed or chair so as to secure the clamp in position by friction fit.

22. A portable isolation unit according to claim 21, wherein the bracket is configured to accommodate the width and thickness of a support mattress or cushion of the bed or chair when the mattress or cushion is inserted therethrough.

23. A portable isolation unit according to claim 19, wherein the backing support member is provided with an opening to which the ventilation unit or a conduit portion of which is mounted thereto.

24. A portable isolation unit according to claim 23, wherein the opening is located at or proximate a part of the backing support member that is furthest from a head portion of a user during use

25. A portable isolation unit according to claim 1, wherein the ventilator comprises a fan unit and a filter unit, wherein the filter unit is configured to filter airflow entering or exiting the fan unit.

26. (canceled)

27. A portable isolation unit according to claim 1, wherein the ventilation unit is configured to provide negative air pressure to an area beneath the enclosure portion when the enclosure portion is in the deployed state.

28. A portable isolation unit according to claim 1, wherein the ventilation unit is configured to provide positive air pressure to an area beneath the enclosure portion when the enclosure portion is in the deployed state.

29. A portable isolation unit according to claim 1, wherein the ventilation unit is provided with a portable power source, which is mountable to the portable frame.

30. (canceled)

31. A method of deploying a portable pressurized chamber over a head portion of a user on a bed or chair, the method involves the steps of:
providing a portable isolation unit according to claim 1;
locating the portable frame to or proximate a head end of the bed;
adjusting the enclosure portion to the deployed state so that the enclosure portion substantially shields over the head portion of the user during use; and
activating the ventilation unit to apply negative or positive air pressure to an area under the deployed enclosure portion.
